(19) United States
(12) Patent Application Publication
(10) Pub. No.: US 2015/0097944 A1
(43) Pub. Date: Apr. 9, 2015

(54) SYSTEM AND METHOD FOR DETECTING AND REPAIRING DEFECTS IN AN ELECTROCHROMIC DEVICE USING THERMAL IMAGING

(71) Applicants: Steve Palm, Minneapolis, MN (US); Jean-Christophe Giron, Edina, MN (US); Philippe Letocart, Raeren (BE); Jerome Rousselet, Herzogenrath (DE); Olivier Selles, Aachen (DE); Katja Werner, Herzogenrath (DE)

(72) Inventors: Steve Palm, Minneapolis, MN (US); Jean-Christophe Giron, Edina, MN (US); Philippe Letocart, Raeren (BE); Jerome Rousselet, Herzogenrath (DE); Olivier Selles, Aachen (DE); Katja Werner, Herzogenrath (DE)

(73) Assignee: SAGE ELECTROCHROMICS, INC., Faribault, MN (US)

(21) Appl. No.: 14/007,708

(22) PCT Filed: Mar. 29, 2012
(86) PCT No.: PCT/US12/31182

§ 371 Date: Dec. 3, 2014

Related U.S. Application Data
(60) Provisional application No. 61/470,083, filed on Mar. 31, 2011.

(51) Int. Cl. G06T 7/00; G01N 25/72

(52) U.S. Cl. CPC G06T 7/0008; G01N 25/72; G06T 2207/10048
USPC 348/129; 382/141

(57) ABSTRACT

System (1) and method (100) for detecting and repairing a defect in an electrochromic device (30) may include acquiring a thermal image of the electrochromic device (30) when the device is in an operating state. In addition, the system and method may include processing thermal imaging data representative of the thermal image to detect a defect in the electrochromic device by comparing a thermal amplitude detected at one or more pixels of the thermal image with a predetermined value, and to determine a location of the electrochromic device corresponding to the detected defect.

### CROSS REFERENCE TO RELATED APPLICATION

The present application claims the benefit of the filing date of U.S. Provisional Application No. 61/470,083, filed Mar. 31, 2011, entitled System and Method for Detecting and Repairing Defects in an Electrochromic Device Using Thermal Imaging, the disclosure of which is hereby incorporated herein by reference.

### FIELD OF THE INVENTION

This invention relates to electrochromic devices which can vary the transmission or reflectance of electromagnetic radiation by application of an electrical potential to the electrochromic device, and more particularly, detecting and repairing defects in an electrochromic device using thermal imaging.

### BACKGROUND OF THE INVENTION

Electrochromic devices include electrochromic materials that are known to change their optical properties, in response to application of an electrical potential, so as to make the device, for example, more or less transparent or reflective, or have a desired coloration.

The manufacture of an electrochromic (EC) device typically includes forming an electrochromic film stack including a plurality of layers of conductive and electrochromic material on a substrate, such as glass. See, for example, U.S. Pat. Nos. 5,321,544, 6,856,444, 7,372,610 and 7,593,154, incorporated by reference herein. During the manufacturing process, defects sometimes may be formed in one or more of the layers of the EC film stack that can cause the electrochromic device to have a different optical behavior than desired, or lack a desired optical behavior, at or near the location of the defect when the device is operated by applying an electrical potential thereto. The defect may be a short between conductive layers of the EC film stack caused, for example, by foreign contaminants, or a material non-uniformity in one or more of layers of the EC film stack that causes the EC device, when operated, to have at the location of the defect optical properties different than those desired and present at locations adjacent the defect. The defect, hence, may cause the EC device to have an undesirable aesthetic appearance when operated.

Some current techniques to detect and repair defects in electrochromic devices rely upon optical detection of the defects. The use of optical detection to detect the location of defects in electrochromic devices, and then to repair the detected defects, however, may be a relatively time consuming process, and also may not always result in satisfactory repair of those defects that cause an undesired aesthetic appearance when the EC device is operated.

Typically, optical imaging of an EC device is performed with an optical imaging system after a substrate, on which an EC film stack has been manufactured, has been cut into smaller sized EC film stack portions for a particular use, such as for attachment in the form of an EC device to a piece of insulating glass; after an EC film stack has been manufactured on a substrate; or after lamination of the EC film stack on the substrate to another piece of glass. A suitable electrical potential is applied to the EC film stack or stack portion for a start-up time interval, such as about 15 to 20 minutes, so that the EC film stack or stack portion may attain an operating state in which the optical properties of the EC film stack or stack portion are according to the design of the EC device. The time period to perform optical imaging of the EC film stack or stack portion to detect defects based on differences in optical emission at locations corresponding to the defects during manufacture of the EC device, therefore, typically includes a start-up time interval.

In addition, an EC film stack may have a memory characteristic, which provides that the EC film stack stores electrical charge, after an electrical potential is applied to the EC film stack, and that the stored electrical charge dissipates rather slowly. As a result, when optical imaging is performed during manufacture of the EC devices to detect the location of a defect without waiting a sufficient time, which may be up to two hours or more, for any collected charge, which may remain from an early testing step during manufacture in which an electrical potential is applied to the EC film stack, to dissipate from the EC film stack, the locations on the EC device identified as having defects may be inaccurate.

Further during EC device manufacture, it is desirable to repair some defects, such as a short between the conductive layers, before power cycling is performed on the EC device. If such shorts are not repaired before power cycling is performed, it is possible that a relatively large region of the EC film stack including the short likely may not be operable, such that the shorts may not be detectable, and thus may not be repairable, after power cycling of the EC device. In addition, some shorts, if not repaired before power cycling, may damage the EC film stack as a result of power cycling.

In addition, it has been observed that some shorts in an EC film stack may not have optical emission characteristics that permit their detection as a defect by an optical imaging system until after the EC device is subjected to power cycling. Therefore, during EC device manufacture, optical imaging to detect and repair defects may need to be performed multiple times.

In addition, an illumination device typically needs to be used with an optical imaging system. The illumination device is operated to illuminate the EC film stack portion from a surface of the EC film stack portion opposing the surface of the EC film stack portion that is optically imaged. Such illumination is provided to ensure there is sufficient contrast in the optical images of the EC film stack portion obtained by the optical imaging system, to permit differentiation between optical emissions at locations of the EC film stack portion including defects and those locations not having defects. The use of an illumination device adds complexity and additional cost to detection and repair of defects in an EC device by an optical imaging system.

Alternatively, defects in EC devices may be visually detected by humans, such as operators of an assembly line for manufacturing EC devices. Such manual detection of defects usually takes about 20 to 40 minutes. In addition, the identification of the location of the defects on the EC device by humans is not very reproducible, so as to allow satisfactory repair of the defects in a subsequent repair step. Consequently, the steps of visually detecting defects by the operators and then repairing the detected defects may need to be repeated one or more times during manufacture of the EC device.

Therefore, there exists a need for detecting and repairing defects in an electrochromic device with a high level of accuracy, quickly, with relative ease and at a relatively low cost.

### SUMMARY OF THE INVENTION

In accordance with an embodiment, a system for detecting and repairing a defect in an electrochromic device may include a thermal imaging unit to acquire a thermal image of an electrochromic device when the device is in an operating state. In addition, the system may include a control unit to detect, using thermal imaging data representative of the thermal image, a defect on the electrochromic device by comparing a thermal amplitude detected at one or more pixels of the thermal image with a predetermined value, and to determine a location of the device corresponding to the detected defect.

In accordance with another embodiment, a method for detecting and repairing a defect in an electrochromic device using thermal imaging may include acquiring a thermal image of the electrochromic device when the device is in an operating state. In addition, the method may include processing thermal imaging data representative of the thermal image to detect a defect on the electrochromic device by comparing a thermal amplitude detected at one or more pixels of the thermal image with a predetermined value, and to determine a location of the electrochromic device corresponding to the detected defect.

In accordance with another embodiment, a system for detecting and repairing a defect in an electrochromic device may include a thermal imaging unit to acquire a thermal image of an electrochromic device when the device is in an operating state. In addition, the system may include a control unit to process thermal imaging data of the thermal image to detect a defect on the electrochromic device and to determine a location on the device corresponding to the detected defect. Further, the system may include a laser device unit to emit laser light to ablate the location of the device corresponding to the detected defect, and a chiller unit to control a temperature of the device when the thermal image is acquired. Also, the control unit may compare a thermal amplitude detected at a pixel of the thermal image to a predetermined value to determine whether the pixel corresponds to a location of a defect on the device.

### BRIEF DESCRIPTION OF THE DRAWINGS

FIG. 1 is a block diagram of a system for detecting a defect in an electrochromic device using thermal imaging, in accordance with an aspect of the invention.

FIG. 2 is a block diagram of a system for detecting and repairing a defect in an electrochromic device using thermal imaging, in accordance with an aspect of the invention.

FIG. 3 is a block diagram of a system for detecting and repairing a defect in an electrochromic device using thermal imaging along an assembly line for manufacturing the electrochromic device, in accordance with an aspect of the invention.

FIG. 4 is a process flow for detecting a defect in an electrochromic device using thermal imaging, in accordance with an aspect of the invention.

FIG. 5 is a process flow for detecting and repairing a defect in an electrochromic device using thermal imaging, in accordance with an aspect of the invention.

FIG. 6 is a process flow for manufacturing an electrochromic device in which thermal imaging is used to detect and repair defects in the electrochromic device, in accordance with an aspect of the invention.

FIG. 7 is an optical image of an exemplary electrochromic device in an operating state.

FIGS. 8A and 8B are thermal images of the electrochromic device of FIG. 7 obtained in accordance with an aspect of the invention.

FIGS. 8C and 8D are three-dimensional plots of the thermal images of FIGS. 8A and 8B, respectively.

FIGS. 8E and 8F are three-dimensional plots of the thermal images of FIGS. 8A and 8B, respectively.

FIGS. 9A and 9B are thermal images of the electrochromic device of FIG. 7 obtained in accordance with an aspect of the invention.

FIGS. 9C and 9D are three-dimensional plots of the thermal images of FIGS. 9A and 9B, respectively.

FIGS. 9E and 9F are three-dimensional plots of the thermal images of FIGS. 9A and 9B, respectively.

### DETAILED DESCRIPTION

In accordance with aspects of the present invention, thermal imaging may be used to detect and locate a defect, such as a short, in an electrochromic device, and to repair and verify a repair of the detected defect of the electrochromic device.

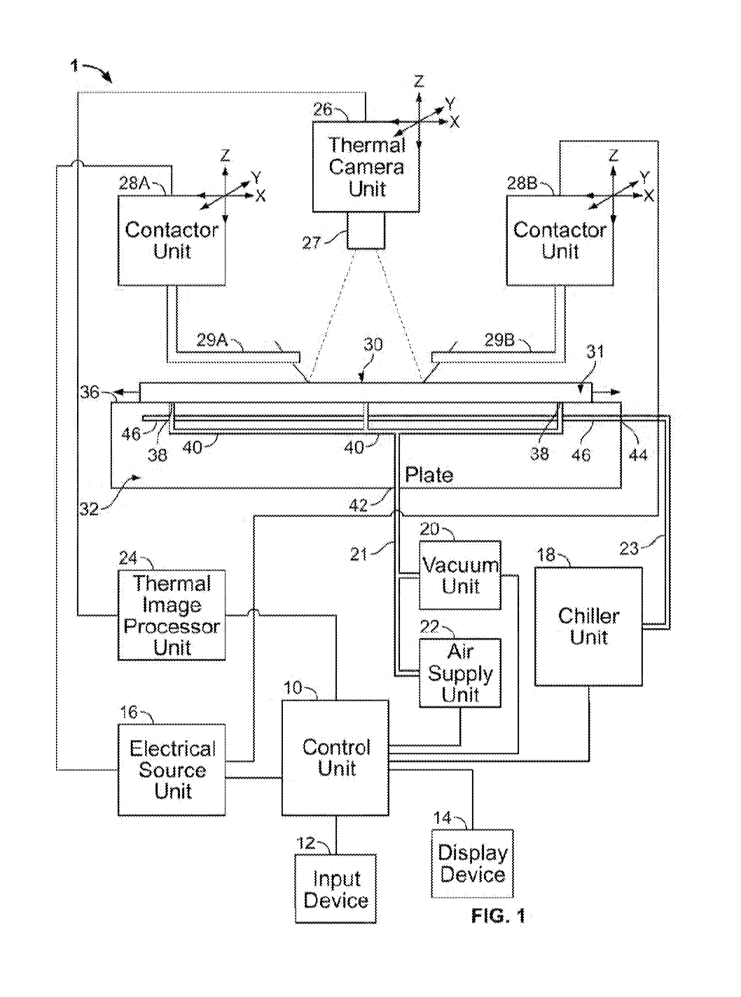

FIG. 1 illustrates a system 1 for detecting a defect in an electrochromic device using thermal imaging, in accordance with an aspect of the invention. Referring to FIG. 1, the system 1 may include a control unit 10 electrically interconnected with an input device 12, a display device 14, an electrical source unit 16, a chiller unit 18, a vacuum unit 20, an air supply unit 22 and a thermal image processor unit 24. In addition, the system 1 may include a thermal camera unit 26 electrically interconnected with the thermal image processor unit 24, and contactor units 28A and 28B electrically interconnected with the electrical source unit 16.

The input device 12 is a conventional device, such as a keypad, keyboard, mouse, switch, etc., that may be operated by a user to supply input information to the control unit 10. The input information may provide for control of the system 1 to detect a defect in an electrochromic device, such as within an electrochromic film stack of an electrochromic device, included in a panel 31 disposed on a plate 32 of the system 1. The panel 31 may be a substrate, such as glass, on which an electrochromic film stack and conductive bus bars electronically interconnected with components of the electrochromic film stack have been formed. The EC film stack and bus bars may be configured on the substrate of the panel 1 such that one or more electrochromic devices can be obtained by cutting the panel into one or more portions, respectively. For ease of reference, detection and repair of defects using thermal imaging, in accordance with the present invention, is described below with reference to an electrochromic device 30 that would be obtained from cutting of the panel 31.

The display device 14 may be any monitor or display screen, such as an LCD or LED display, that can display information supplied by the control unit 10.

The chiller unit 18 may be any device that can be controlled, such as by the control unit 10, to supply a gas, such as air, nitrogen, argon or helium, or liquid at a temperature and a flow rate to reduce and maintain the temperature of the plate 32 at or below a predetermined temperature, such as about 65° F. Based on control of the operation of the chiller unit, the temperature of the EC device 30, which is disposed on the plate 32, may be reduced to, and maintained at, a desired temperature, such as about 50° F.

The plate 32 may be in the form of a housing having a substantially planar outer surface 36 of sufficient size to hold the panel 31 thereon. The plate 32 may further include one or more holes 38 opening at the outer surface 36, and conduits 40 extending from the holes 38 to an input port 42.

The air supply unit 22 may be a device that can be controlled, such as by the control unit 10, to supply a desired flow rate of compressed air. The compressed air may be applied through a conduit 21 that terminates at the input port 42 of the plate 32.

The vacuum unit 20 may be any device that can be controlled, such as by the control unit 10, to create a vacuum. The vacuum may be applied through the conduit 21 to the input port 42 of the plate 32.

The thermal camera unit 26 may include a thermal imaging camera, such as an infrared camera, with a lens 27. The lens 27 of the camera may be controllable to move in three degrees of freedom (x, y, z), and the thermal imaging camera may be controllable to acquire thermal images and supply thermal imaging data representative of the acquired thermal images. The lens 27 may be, for example, an infrared f/1.4, 25 mm objective lens or an infrared f/3.0 Marco 1× lens. It is to be understood that one skilled in the art may select an infrared lens having a suitable aperture and focal length to acquire thermal images that can be used to detect and locate a defect in an EC device, as described below.

The thermal image processor unit 24 may, based on control data supplied from the control unit, control operation of the thermal camera unit 26, such that the lens 27 of the thermal camera unit 26 is moved to a desired position relative to the plate 32 and thermal images of the EC device 30 on the plate 32 are acquired by the camera unit 26. In addition, the thermal image processor unit 24 may process thermal imaging data from the camera unit 26, and supply the processed thermal imaging data, and also the thermal imaging data from the camera unit, to the control unit 10.

The contactor units 28 may be a device that includes a contact element 29 that can be controlled to move in three degrees of freedom (x, y, z). The contactor units 28 are disposed in relation to the plate 32 so that the contact element 29 may be moved into contact with a desired location of the EC device 30, such as a bus bar or like contact point of the EC film stack of the device 30 at which an electrical potential can be applied to switch the EC device to an operating state. When an electrical potential is applied between negative and positive terminals of the EC device, the EC device 30 may switch from a non-operating state to an operating state in which the optical characteristics of the EC film stack, and thus, the device 30, may attain a desired, predetermined state, e.g., a colored or tinted state.

The electrical source unit 16 may be a device that can be controlled, such as by the control unit 10, to supply position control data to the contactors 28 to cause movement of the contact elements 29 into contact with desired locations of the EC device 30. Further, the electrical source unit 16 may control the characteristics of a low voltage electrical signal applied to the EC device 30 with the contact elements of the contactors 28A and 28B.

The control unit 10 is a data processing device including a processor and a memory for storing data and instructions executable by the processor, such as a computer or like device. The control unit 10 is adapted to process input data supplied by the input device 12, and supply control data to the chiller unit 18, the vacuum unit 20, the air supply unit 22, the thermal image processor unit 24 and the electrical source unit 16 for performing a process to detect a defect in an electrochromic device by thermal imaging, in accordance with aspects of the invention. In one embodiment, the control unit 10 may be configured to perform one or more of the functions performed by other units of the system 1 as described herein.

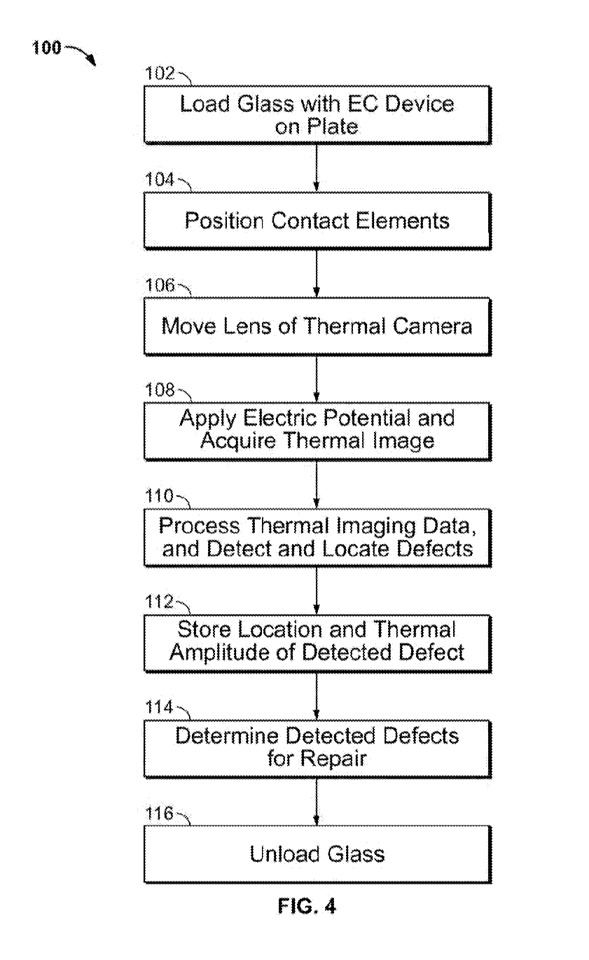

FIG. 4 illustrates an exemplary process 100 to detect a defect in an electrochromic device, in accordance with aspects of the present invention. For purpose of illustration, the process 100 is described in connection with operations performed by components of the system 1 of FIG. 1, as described above.

Referring to FIG. 4, in block 102, the control unit 10 may supply control data to the air unit 22 that causes compressed air to be supplied by the air unit 22 through the conduit 21. After supply of compressed air is started, the electrochromic device 30, which may be part of a panel including a sheet of glass coated with an electrochromic film stack and having conductive bus bars formed thereon electrically interconnected with the electrochromic film stack, may be moved onto the surface 36 of the plate 32. The compressed air may be clean and dry air or nitrogen.

After the EC device is disposed on the plate 32, the supply of compressed air may be stopped, and the control unit may control the vacuum unit 20 to create a vacuum in the conduit 21. The vacuum is provided to maintain the EC device substantially immovable on the surface 36 of the plate 32.

In one embodiment, the plate 32 may contain an input port 44 in communication with a conduit 46 that extends within the interior of the plate 32 and is arranged adjacent the surface 36. The control unit may control the chiller 18 to supply a liquid or gas, such as chilled air or liquid, through a conduit 23 to the input port 44 and into the conduit 46, so as to reduce the temperature of the plate 32. The cooling of the plate 32, such as to a temperature of about 65° F., in turn provides for cooling of the EC device 30 held in contact with the plate surface 36 to a desired, uniform temperature. By cooling the EC device 30 prior to switching the EC device to an operating state by applying a suitable electrical potential thereto, the detection of defects, such as a short, in the EC film stack of the EC device 30 using thermal imaging may be enhanced. The cooled EC device 30 may be maintained at a stable, uniform temperature, such that by use of thermal imaging, heat generated from a region of the EC device having a defect, such as a short, is readily distinguishable from regions of the EC device surrounding or adjacent the defect that do not have defects generating heat. In addition, by cooling the plate 32 so it serves as a uniform thermal background to the EC device, a signal-to-noise ratio of thermal amplitude detected for a portion of the EC film stack including a short to thermal amplitude detected for a portion of the EC film stack without defects surrounding or adjacent the portion including the defect may be increased.

In block 104, the control unit 10 may, based on input information received at the input device 12, provide control data to the electrical source unit 16 to cause the contactor units 28A and 28B to move their respective contact elements 29A and 29B into contact with respective positive and negative bus bars (not shown) of the EC device 30. In one embodiment, the control of the positioning of the contact elements may be performed automatically, based on data stored in the memory of the control unit indicating the dimensions of the EC device 30, the locations of the bus bars on the EC device and the position on the surface 36 of the plate 32 at which the EC device is held.

In block 106, the thermal image processor unit 24 may control the thermal camera unit 26 to move the lens 27 to a predetermined position above the surface of the EC device 30 facing the lens 27.

In block 108, the control unit 10 may control the electrical source unit 16 to apply a predetermined electrical potential, such as a square wave, across the bus bars of the EC device 30 contacting the respective contact elements 29A and 29B. The duty cycle, duration, frequency and power level of the electrical potential applied may be controlled, based on control data from the control unit, where the control data is determined from data stored in the memory of the control unit or input information supplied from the input device 12.

Further in block 108, when the electrical potential is applied to the EC device, the thermal image processor unit may control the thermal camera unit to acquire thermal images of the EC device at a predetermined rate and synchronized with the application of the electrical potential. Thermal imaging data representative of the acquired thermal images may be supplied from the thermal image processor unit to the control unit, and then stored in the memory of the control unit with information correlating the acquired thermal images to the timing of the electrical potential applied.

In block 110, the control unit 10 may process the thermal imaging data to determine differences between detected thermal amplitudes at different pixels in a thermal image to detect and identify the locations of defects in the EC film stack. The defects may include, for example, shorts between the two conductors of the EC film stack that are regions of the EC film stack that would draw more current than regions of the EC film stack adjacent the regions with the shorts when the ED device in an operating state. The increased current in the EC film stack at the shorts generates heat or thermal radiation, which may be detected by a thermal imaging camera. In one embodiment, the amplitude of thermal radiation detected at each pixel of a thermal image of an EC device acquired by the thermal imaging camera may be determined by the thermal image processor unit.

In one embodiment, the electrical potential applied to the EC device may be modulated at a predetermined frequency and thermal imaging data may be obtained from acquired thermal images to identify the location of a defect with a high level of precision. The elevated temperature generated from the higher levels of current flowing through shorts of the EC film stack may allow detection of the location of shorts in the EC film stack by use of thermal imaging. In one embodiment, the defect may be detected and located by iteratively analyzing the thermal imaging data representative, respectively, of thermal images acquired in a series, and reducing the size of the region of the EC device thermally imaged while maintaining the defect positioned in the center of the thermal images, thereby locking in on the defect and its location in the EC device and, advantageously, increasing the signal-to-noise ratio of the defect. See, for example, Huth, S., et al., “Lock-in Thermography—a novel tool for material and device characterization,” Solid State Phenomena, Vol. 82-84, pp. 741-746 (2002), incorporated by reference herein, which describes a lock-in thermography technique.

In one embodiment, in block 110 a comparison among the thermal amplitudes of respective pixels of a thermal image may be performed to identify the pixels of the thermal image having thermal amplitudes that may be associated with a defect, such as a short, in the EC film stack. The identified pixels are determined to correspond to the locations of defects on the EC film stack of the EC device.

In one embodiment, the control unit 10 may control positioning of the location of the lens 27 and the electrical potential applied to the EC device to increase a signal-to-noise ratio of thermal amplitude detected for a portion of an EC film stack including a defect to thermal amplitude detected for a portion of the EC film stack without defects adjacent to the portion including the defect, such as by use of an iterative procedure to lock-in on the defect as described above.

In one embodiment, the thermal imaging data for a thermal image may be processed so as to display on a display screen thermal amplitudes two-dimensionally in correspondence with the EC device thermally imaged, and display the thermal amplitudes with indicia, for example, coloring, shading or the like, such that regions having defects may be readily distinguished on the display screen from other regions of the EC device not having defects. For example, the thermal amplitudes may be displayed having a brightness proportional to their absolute values.

In block 112, the control unit 12 may store, for each thermal image, the thermal amplitude detected at each pixel and the location(s) on the EC device corresponding to each pixel of the thermal image.

In block 114, the control unit 12 may process the stored thermal imaging data to provide a filtering function, in which a location on the EC device corresponding to a pixel of a thermal image of the EC device having a thermal amplitude below a predetermined threshold value is not identified as corresponding to a defect. Further in block 114, the control unit may store in its memory data indicating the locations on the EC device corresponding to the defects that remain after the filtering, to allow for subsequent repair of the defects.

In block 116, the control unit may control the vacuum unit to cease providing a vacuum, and then control the air unit to supply compressed air to provide that the panel 31 including the device 30 may be removed from the plate 32.

In an exemplary implementation of the invention, an exemplary system having components and functions the same as or similar to those described above for the system 1 was used to perform thermal imaging of an exemplary EC device including an EC film stack having length and width dimensions of 35 mm by 41 mm, respectively, and disposed on a glass substrate having a thickness of 2 mm. FIG. 7 is an optical image obtained of such EC device when in an operating state. Referring to FIG. 7, it can be observed from the optical image that the EC device has multiple shorts as defects, including a pronounced short adjacent and to the right of the center of the image.

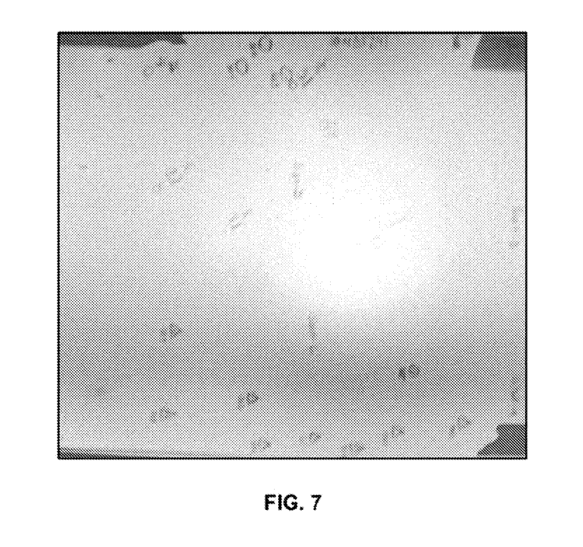

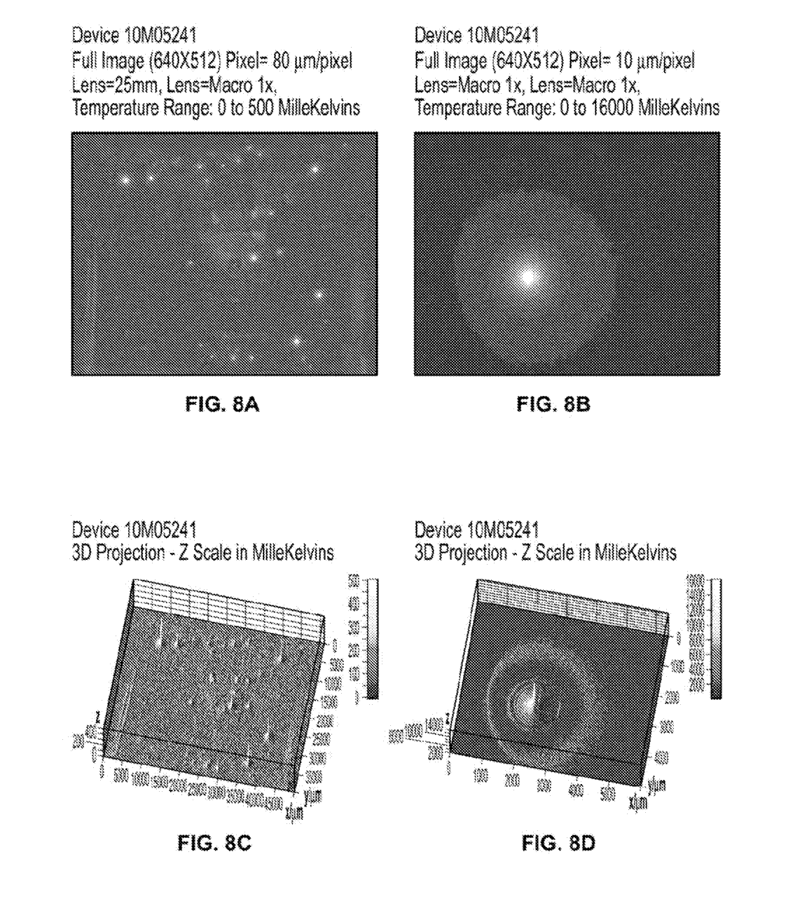

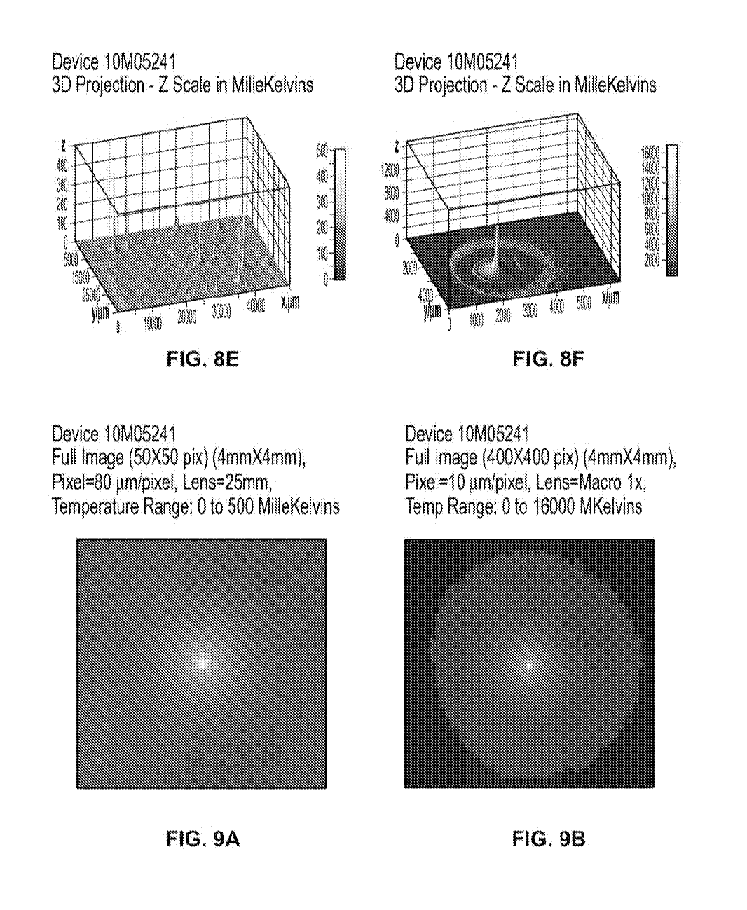

Thermal images of the exemplary EC device were obtained with a thermal camera unit of the exemplary system having a 25 mm IR objective lens positioned above the EC device to provide a resolution of 80 μm/pixel, and also using a Macro 1× IR objective lens positioned above the EC film device to provide a resolution of 10 μm/pixel. FIGS. 8A and 8B show thermal images of the entire EC device of FIG. 7 acquired using the 25 mm and Macro 1× lenses, respectively.

In addition, the thermal imaging data was processed to display the thermal amplitude of each pixel of the thermal images shown in FIGS. 8A and 8B in three dimensions to accentuate thermal regions corresponding to defects, as shown in FIGS. 8C and 8E and FIGS. 8D and 8F, respectively. It was found that the thermal imaging performed with the 25 mm lens resulted in a peak of about 350 milleKelvins (0.35° C.) at a short as shown in FIGS. 8C and 8E, whereas the thermal imaging performed with the Macro 1× lens resulted in a peak of about 16,000 milleKelvins (16° C.) at the same short as shown in FIGS. 8D and 8F. The difference between the peak thermal amplitudes (temperatures), respectively, of the two different lenses for the same short occurs because each pixel averages thermal emission from multiple regions and the region of the EC device containing the short is typically small, such as about 10 μm. Consequently, for the same short, where a pixel corresponds to a larger region of the EC film stack, the thermal imaging data for the pixel has smaller temperature differences compared to the background (baseline) temperature of the EC film stack. In other words, a signal-to-noise ratio of thermal amplitude (temperature) for a defect in an EC film stack to thermal amplitude for portions of the EC film stack without defects decreases with increase in size of the region of the EC device represented by each pixel.

In some embodiments of the system 1, the pixel size of thermal images acquired may be varied to provide for larger fields of view to increase throughput during testing of an EC device for defects during EC device manufacture, with a corresponding decrease in sensitivity, and vice versa.

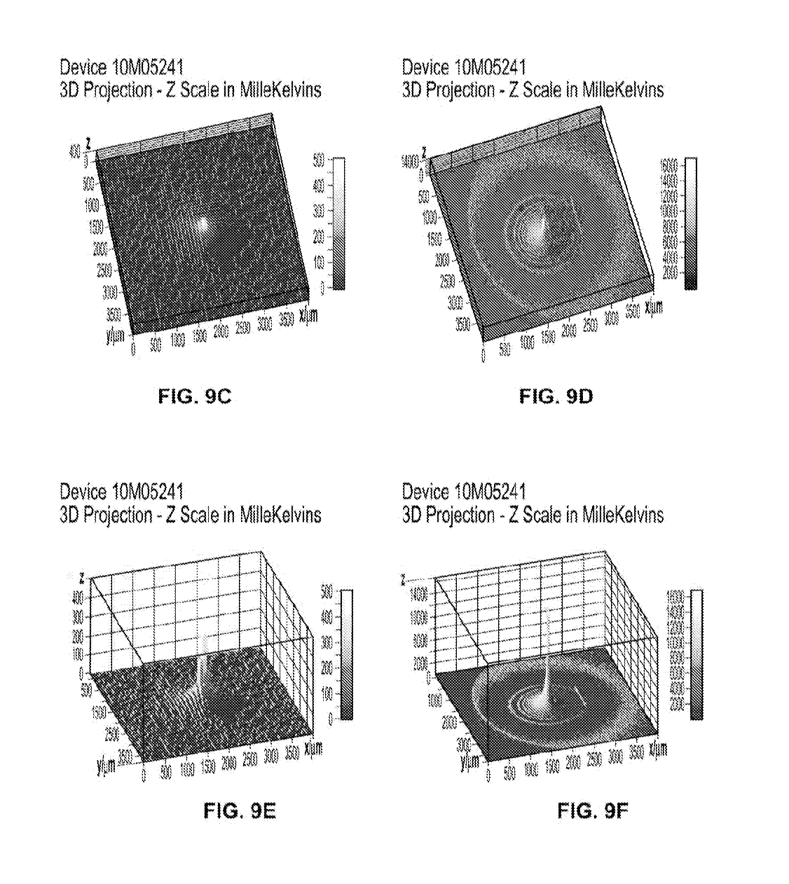

FIGS. 9A-9B show thermal images of the same EC device of FIG. 7 obtained by thermal imaging using the 25 mm lens and the Macro 1× lens, respectively, where the thermal images are of a 4 mm by 4 mm region of the exemplary EC device including the defect in the EC film stack located at the center of the region. FIGS. 9C and 9E, and FIGS. 9D and 9F, show three-dimensional displays, respectively, of the thermal imaging data of FIGS. 9A and 9B.

In one embodiment of operation of the system 1, the electrical potential may be applied to an electrochromic device in the form of a square wave and the thermal images may be acquired as follows: (1) the electrical potential is −3 volts for 100 seconds, 0 volts for the next 100 seconds, and −3 volts for a final 100 seconds, and the thermal images are acquired at a rate of 2.2 Hz; (2) the electrical potential is −2 volts for 100 seconds, 0 volts for the next 100 seconds, and −2 volts for a final 100 seconds, and the thermal images are acquired at a rate of 2.2 Hz; (3) the electrical potential is 3 volts for 100 seconds, −2 volts for the next 100 seconds, and 3 volts for a final 100 seconds, and the thermal images are acquired at a rate of 2.2 Hz; (4) the electrical potential is −2 volts for 100 seconds, 0 volts for the next 100 seconds, and −2 volts for a final 100 seconds, and the thermal images are acquired at a rate 2.2 Hz; (5) the electrical potential is −2 volts for 10 seconds, 0 volts for the next 10 seconds, and −2 volts for a final 10 seconds, and the thermal images are acquired at a rate of 22 Hz; (6) the electrical potential is −2 volts for 3.3 seconds, 0 volts for the next 3.3 seconds, and 2 volts for a final 3.3 seconds, and the thermal images are acquired at a rate of 80 Hz; (7) the electrical potential is 3 volts for 3.3 seconds, 0 volts for the next 3.3 seconds, and 3 volts for a final 3.3 seconds, and the thermal images are acquired at a rate 80 Hz; (8) the electrical potential is 5 volts for 3.3 seconds, 0 volts for the next 3.3 seconds, and 5 volts for a final 3.3 seconds, and the thermal images are acquired at a rate of 80 Hz; (9) the electrical potential is 7 volts for 3.3 seconds, 0 volts for the next 3.3 seconds, and 7 volts for a final 3.3 seconds, and the thermal images are acquired at a rate of 80 Hz; and (10) the electrical potential is applied for 400 seconds using two consecutive 200 second impulses as follows: 3 volts for the first 50 seconds, 0 volts for the next 50 seconds, −2 volts for the next 50 seconds; and the thermal images are acquired at a rate of 2.2 Hz.

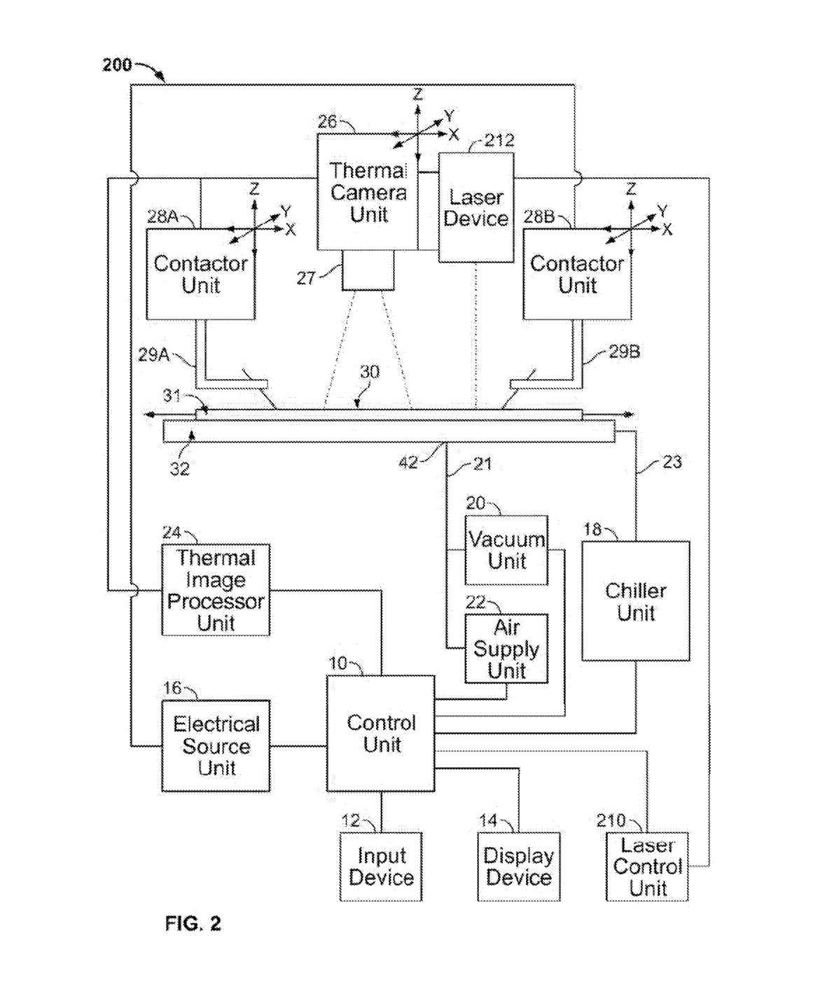

In another aspect, referring to FIG. 2, a system 200 may provide for detecting and repairing a defect in an electrochromic device using thermal imaging. Referring to FIG. 2, the system 200 may include the same or similar components as described above for the system 1 and, further, a laser control unit 210 electrically interconnected to the control unit 10 and a laser device 212.

The laser device 212 may be an optical energy emission device, such as a laser, that can be controlled to emit a beam of optical light at a sufficient energy to ablate a focused area of less than about 15 square microns positioned at a distance of less than about 20 mm away from the laser. In addition, the laser device 212 may be controlled to move in three degrees of freedom (x, y, z).

The laser control unit 210 may operate to control emission and intensity of laser light emitted, and also movement of the laser device 212, based on control data supplied by the control unit 10.

In one embodiment, the laser device 212 may be secured to, and desirably be integral with, the thermal camera unit 26.

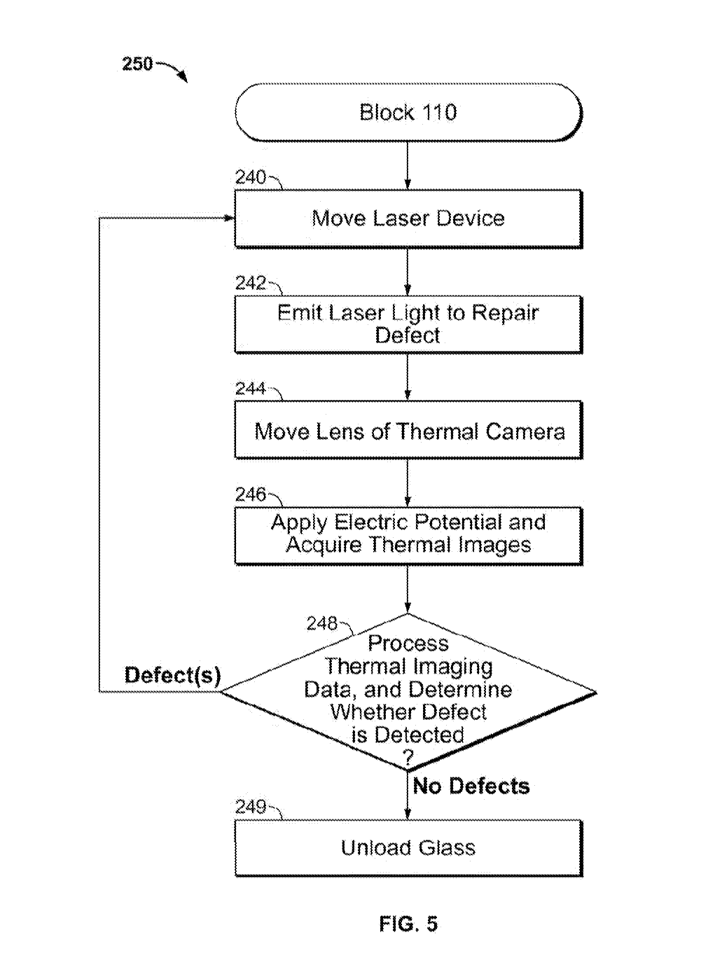

FIG. 5 illustrates an exemplary process 250 that may be performed in connection with the system 200 to detect a defect in an EC device using thermal imaging, repair the detected defect and then verify, using thermal imaging, whether the detected defect has been satisfactorily repaired. The process 250 may include the same functions as described above for the blocks 102, 104, 106, 108 and 110 of the process 100, which are not shown in FIG. 5.

Referring to FIG. 5, after blocks 102, 104, 106, 108 and 110 are performed as described above, in block 240 the control unit may control movement of the laser device 212 to position the laser device in relation to the EC device, such that laser light emitted from the laser device 212 may impinge upon a location(s) on the EC device corresponding to a pixel or pixels of a thermal image of the EC device determined to have a thermal amplitude exceeding a predetermined threshold, which corresponds to the location of detected short. The positioning of the laser device 212 may use data indicating the size of the EC device and its position on the plate 32 stored in the memory of the control unit.

In block 242, the laser control unit 210 may cause the laser device to emit laser light at a suitable wavelength and of sufficient intensity to ablate the location(s) in the EC film stack of the EC device corresponding to the pixel(s) of a thermal image of the EC device determined to have thermal amplitudes exceeding the predetermined threshold. For example, the intensity of laser light may be between 300-500 mW. In addition, the laser light beam may have a width of 50-250 μm in diameter and a power density of at least 2×10⁷ W/cm². In an alternative embodiment, the laser device may be controlled to repair a defect by ablating portions of the EC film stack circumscribing the defect.

In block 244, the thermal camera unit 26 may be controlled to move the lens 27 to a position over the EC device at which a thermal image of a location(s) of the EC film stack corresponding to the location(s) at which defect repair has been performed by laser ablation in block 242 can be acquired.

In block 246, the electrical source and the thermal camera unit may be controlled by the control unit to acquire thermal images of the EC device when in an operating state, similarly as described for block 108.

In block 248, the thermal imaging data corresponding to the thermal images acquired in block 246 may be processed, similarly as in block 110, to determine whether any defects are indicated by the thermal imaging data. For example, a determination is that a short exists, in other words, a short is detected in block 248, if the thermal amplitude for a pixel of the thermal image acquired exceeds a predetermined threshold at locations of the EC film stack corresponding to the locations that underwent defect repair in block 242. After a short in the EC film stack is repaired, the location of the EC film stack identified as having the short should no longer radiate heat at an elevated level, such that the thermal amplitude of the pixel(s) of a thermal image corresponding to the location of the repaired short is below the predetermined threshold. If no defect is detected in block 248, the operations of block 116, as discussed above, may be performed in block 249 to remove the panel including the EC device from the plate 32. If a defect is detected in block 248, a further repair procedure may be performed by repeating the operations of blocks 240, 242, 244, 246 and 248.

In another embodiment, if a defect is detected in block 248, the control unit may provide an alert signal, such as on a display unit or another output device, such as an audible alert on speakers connected to the control unit, to indicate, such as to an operator of the system, that the EC device contains a defect that may cause undesired aesthetic effects when the electrochromic device is in an operating state. The control unit further may provide on the display unit information indicating the location(s) of the defect(s) on the EC device, as determined in block 248.

In a further embodiment, a short that is detected as a defect by operation of the system 1 as described above may be repaired, by applying a gradually increasing current to the EC device, for example, supplied from the electrical source unit 16 and applied using the contactor units 28, to heat the short until the short self-isolates from conductive layers in the EC device. The control unit may control acquisition of successive thermal images while the repair is being performed, and analyze thermal imaging data representative of the thermal images also while the repair is being performed, to determine automatically when the short has been repaired, at which time the control unit controls the electrical source unit such that current is no longer applied to the EC device.

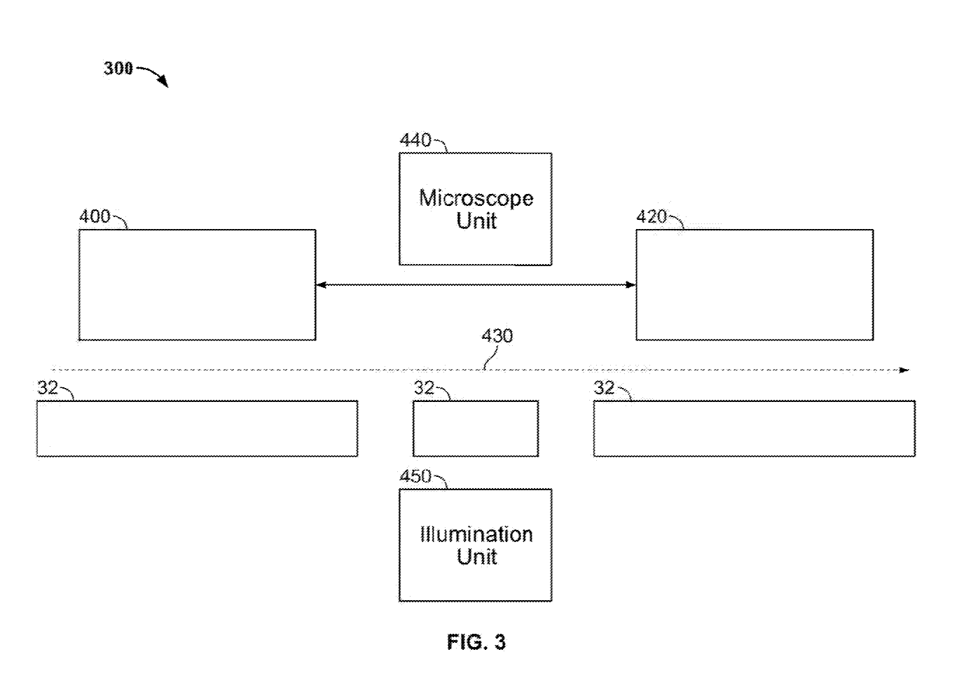

FIG. 3 illustrates an exemplary system 300 for detecting and repairing defects in an EC device, where the system 300 is part of an assembly line for manufacturing EC devices. Referring to FIG. 3, the system 300 may include a system 400 for detecting locations of defects in an EC device using thermal imaging, where the system 400 is the same as or similar to the system 1 as described above. The system 400 may precede a system 420 along an assembly line 430. The system 420, which may be the same as or similar to the system 200 as described above, may provide for, using thermal imaging, repair of defects and verification of repair of defects detected by the system 400, at a subsequent stage during manufacture of the EC device.

In one embodiment, a microscope unit 440, which may be controllable by and exchange data with a control unit of either of the systems 400 and 420, may be disposed along the assembly line 430 between the systems 400 and 420. The microscope unit 440 may be operable to obtain high resolution images of selected locations on the EC device being manufactured, and in particular those locations identified as having defects by the system 400.

In one embodiment, an illumination unit 450, such as a light source, may be arranged facing a surface of the EC device opposite the surface of the EC device facing the microscope unit 440. The illumination unit 450 may be operated, under control of the control unit of either of the systems 400 or 420, to illuminate selected regions of the EC device to provide greater contrast for the optical images acquired by the microscope unit 440.

In one embodiment, the thermal resolution of the thermal imaging of the system 400 may be less than the thermal resolution of the thermal imaging of the system 420.

In one embodiment, thermal imaging of an EC device may be performed to identify non-uniformities in the EC film stack, or in the substrate upon which the EC film stack is applied or deposited. The non-uniformities in the EC film stack, for example, may be the existence of regions of the EC film stack having different thicknesses. The non-uniformities may be detected by thermal imaging, because heat transfer that occurs from the surface of the EC device to the layers in the EC film stack may occur unevenly if the layers do not have strong bonds. For example, thermal imaging may be used to detect delamination of the layers of the EC film stack from each other, or of the EC film stack from the underlying substrate.

In another embodiment, thermal imaging may be performed to detect non-uniformities and uneven adhesion in bus bars of an EC device, high contact resistance between bus bars and portions of the EC film stack, and weak or failed solder joints and wire attachments of an EC device.

In one embodiment, an opaque sheet of material, such as a sheet of black paper, may be disposed on the surface 36 of the plate 32 to avoid reflections of thermal radiation from the EC device from being measured in thermal images. By minimizing reflections of thermal radiation from the EC device, in a thermal image acquired of EC device there may be increased contrast between thermal radiation measurements of regions having defects and those regions without defects.

In a further embodiment, a filtering element, such as a glass sheet, may be placed on or be a part of the lens of a thermal camera unit, such as the unit 26 of the system 1, or adjacent to the EC device being thermally imaged.

In another embodiment, the plate 32 may be adapted to permit thermal imaging of the EC device from either side of the EC film stack by the thermal camera unit, with or without a filtering element between the EC device and the lens of the thermal camera unit. In a further embodiment, the plate 32 may be adapted to serve as a filtering element through which thermal images of the EC device being maintained on the plate may be acquired by the thermal camera unit.

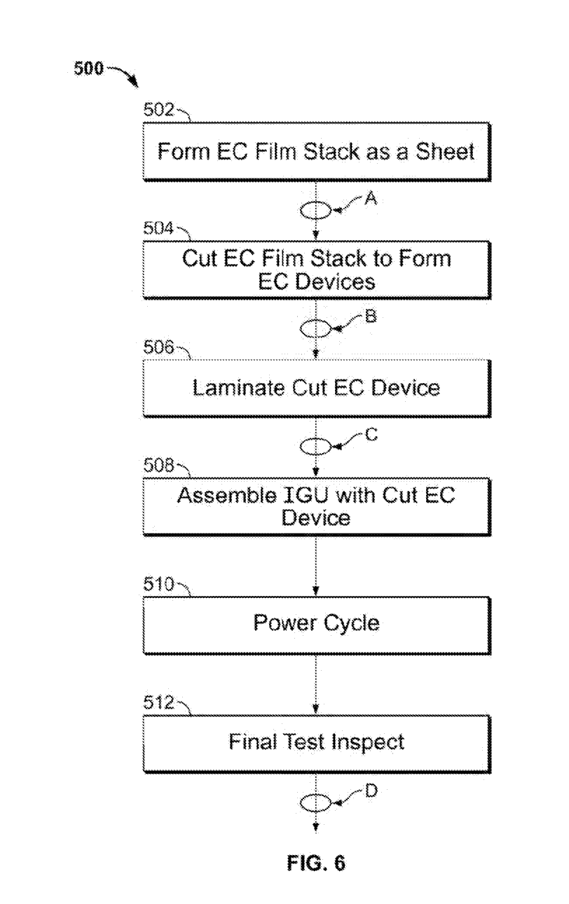

Referring to FIG. 6, which shows an exemplary EC device manufacturing process 500, the use of thermal imaging, in accordance with the present invention, to detect defects and to verify the repair of the detected defects during manufacture of an EC device may be performed at various stages of the process 500 without substantially increasing the production time of EC device products. For example, defects may be formed in the EC film stack of the EC device due to (i) contamination on the surface of the substrate glass on which the EC film stack is formed, (ii) contamination in one or more of the layers of the EC film stack that results during coating of the substrate, and (iii) laser and other processing of the EC film stack during its formation on the substrate that may form regions in the EC film stack that draw an excessive current when the EC device is in an operating state.

Thermal imaging to detect and repair such defects may be performed at a manufacturing stage A (see FIG. 6), which is after block 502 and before block 504 of the process 500. In block 502, a panel including one or more EC devices may be formed by coating a substrate, such as glass, with layers of conductive and electrochromic material to form an EC film stack, performing laser scribe processing on the EC film stack and then heating the panel in an oven. In some current manufacturing processes, block 502 further may include a testing and repair operation, which is performed subsequent to heating the panel in an oven and repairs hard shorts in an EC device by applying an increasing electrical current to the EC film stack, similarly as described above. The repair of hard shorts with electrical charge is typically imprecise and may damage the EC devices, such that the damage would need to be repaired during a final testing operation, such as performed in block 512 as discussed below. In block 504, the panel is cut into a desired size(s) corresponding to the EC device(s) that are to be incorporated into respective EC device products, such as described in U.S. application Ser. No. 13/040,787 filed Mar. 4, 2011 and U.S. application Ser. No. 13/178,065 filed Jul. 7, 2011, the disclosures of which are incorporated by reference herein.

The repair of defects at stage A before cutting of the panel in block 504 allows early detection and repair of defects of each EC device on the panel. The locations of the defects may be detected with a relatively high degree of accuracy at the stage A, because the thermal images obtained at this stage of manufacture of the EC device are likely to have high contrast between defect and non-defect regions. Further, data concerning the defects detected at this stage may be used to help eliminate sources of defects during the conductive and electrochromic material coating steps performed to form the EC film stack.

In one embodiment, in stage A each of the one or more EC devices of the panel may be repaired by applying electrical current to the EC film stack, and using feedback information in the form of thermal imaging data representative of thermal images acquired of the panel, to verify successful repair of any shorts. In some embodiments, the panel may be cooled, such as by the chiller unit 18 of the system 1, to protect the EC film stack from damage and the amplitude of current applied to an EC device of the panel may be increased at a relatively slow rate to remove the source of the short, such as by burning a region of the EC film stack including the short which isolates the region of the short from the conductive layers of the EC film stack. The amplitude of the current may be increased while monitoring thermal images of the panel, automatically by the control unit of the system or by observing a display of the thermal images, such that the current is increased until it is determined from the monitoring, automatically by the control unit or by an operator observing the display, that the shorts are eliminated. In a further embodiment, the repair of defects using thermal imaging in stage A may be performed successively on each of a plurality of EC devices included in a panel.

The repair using thermal imaging performed in stage A is in contrast to some prior art defect repair techniques performed after cutting of the EC device, in which the cut EC devices are tested as part of a testing procedure that automatically detects defects and stores data concerning the detected shorts, but does not repair detected shorts.

In an alternative embodiment, thermal imaging to detect and repair defects may be performed on an EC device which is formed without cutting the EC film stack, such as an EC device obtained by forming the EC film stack on a substrate of the same size as an insulated glass substrate on which the EC device is to be applied.

Referring again to FIG. 6, thermal imaging to detect and repair defects may be performed at a manufacturing stage B, which is after block 504 and before block 506. In block 506, the cut EC device undergoes lamination, such as described in U.S. application Ser. No. 13/040,787, filed Mar. 4, 2011, incorporated by reference herein.

Further, thermal imaging to detect and repair defects may be performed at a manufacturing stage C, which is after block 506. In block 506, defects, such as shorts, can be created from contamination on rollers used to apply a laminate to the cut EC device. In stage C, the repair of shorts using thermal imaging may be performed the same or similarly as performed in stage A as described above.

Referring to FIG. 6, the process 500 may include, after block 506, block 508, in which the EC device product, such as an insulating glass unit (IGU), is assembled with the cut EC device, and blocks 510 and 512, in which power cycling and then final testing and inspection, respectively, are performed on the EC device product. Defects, such as shorts, which may not be detectable using optical imaging or thermal imaging before power cycling of the EC product is performed, may be detected and repaired using thermal imaging at a manufacturing stage D that is subsequent final testing and inspection in block 512.

Advantageously, the relatively short time, for example, about 30 seconds, in which defect detection and repair using thermal imaging may be performed for an EC device, permits detection and repair of detects at multiple stages during manufacture without substantially impacting EC device production rates and time. Further, the time for power cycling the EC device product may be minimized, because thermal imaging that is performed before the power cycling may allow for detection and repair of defects that cannot be detected optically until after power cycling is performed. Also, the use of thermal imaging to detect and repair detects may avoid the need to repair defects at a final testing step of the EC device product, during which repair may become complicated because non-clear material layers may have been attached to the EC device to form the EC device product. In addition, when a thermal image of an EC device is acquired at different times during manufacture of the EC device, the location on the EC device determined for the same defect is reproducible with a high degree precision for the different thermal images.

In a further aspect, the components of the system 1 or the system 200 may be integrated into a portable unit. The portable thermal imaging defect detection and repair unit may include a securing element for holding the unit against an EC device product, such as a window of a building which constitutes the EC device product. The securing element may include suction-cups for securing to the EC device product and which are attached to a tripod from which a moveable support extends. The support may be fixedly connected to the thermal imaging camera unit and the laser device, and may be moved to allow for positioning of the camera unit and the laser device at a desired position in relation to the EC device product. The laser device included in the portable unit may be a 532 nm Q-switched laser controllable to emit pulse widths of about 7 nsec and have a 20 KHz repetition frequency and provide for power levels of about 100-400 mW.

In one embodiment, the portable unit may include an optical camera unit to capture optical images of the EC device product, and the control unit may display the optical images on the display of the portable unit, along with or separately from thermal images of the EC device product. In addition, the portable unit may include a communications unit to communicate thermal imaging data, and other data processed or collected at the portable unit, by wireless or wired communication.

In addition, it is to be understood that the detecting and repairing of a defect in an EC device using thermal imaging, in accordance with the features of the invention as described above, is similarly applicable for detecting and repairing a defect, using thermal imaging, in a photovoltaic device, in an EC device having a non-solid state integrated circuit therein, a thermochromic device and in liquid crystal material layers included in a liquid crystal device.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for detecting and repairing a defect in an electrochromic device, the system comprising:
a thermal imaging unit to acquire a thermal image of an electrochromic device when the device is in an operating state; and
a control unit to detect, using thermal imaging data representative of the thermal image, a defect on the electrochromic device by comparing a thermal amplitude detected at one or more pixels of the thermal image with a predetermined value, and to determine a location of the device corresponding to the detected defect.

2. The system of claim 1 further comprising:
a laser device unit to emit laser light to ablate the location of the device corresponding to the detected defect.

3. The system of claim 1 further comprising:
a chiller unit to control a temperature of the device when the thermal image is acquired.

4. The system of claim 1, wherein the control unit determines the one or more pixels corresponds to a location of a defect on the device when the thermal amplitude detected at the one or more pixels is not less than the predetermined value.

5. The system of claim 1, wherein the control unit processes the thermal imaging data to increase a signal-to-noise ratio of thermal amplitude of a portion of the thermal image corresponding to the detected defect to thermal amplitude of a portion of the thermal image adjacent the portion of the thermal image corresponding to the detected defect.

6. The system of claim 1, wherein the control unit is to control a thermal state of a surface on which the device is disposed, the surface being opposite a surface of the device of which the thermal image is acquired.

7. The system of claim 6, wherein the control unit is to control the thermal state of the surface to increase a signal-to-noise ratio of thermal amplitude of a portion of the thermal image corresponding to the detected defect to thermal amplitude of a portion of the thermal image adjacent the portion of the thermal image corresponding to the detected defect.

8. The system of claim 1, wherein the predetermined value is other than a thermal amplitude determined from a thermal image of the electrochromic device.

9. The system of claim 1, wherein the predetermined value corresponds to a thermal amplitude determined from the thermal imaging data.

10. The system of claim 1, wherein the control unit processes the thermal imaging data representative, respectively, of a series of thermal images acquired by the thermal imaging unit using a lock-in process to increase signal-to-noise ratio of the detected defect.

11. The system of claim 1, further comprising:
a repair unit to apply an electrical current to the device to repair the detected defect.

12. The system of claim 11, wherein the control unit controls the repair unit based on the thermal imaging data.

13. A method for detecting and repairing a defect in an electrochromic device using thermal imaging, the method comprising:
acquiring a thermal image of the electrochromic device when the device is in an operating state; and
processing thermal imaging data representative of the thermal image to detect a defect on the electrochromic device by comparing a thermal amplitude detected at one or more pixels of the thermal image with a predetermined value, and to determine a location of the electrochromic device corresponding to the detected defect.

14. The method of claim 13 further comprising:
controlling repair of the detected defect on the EC device based on the determined location.

15. The method of claim 14, wherein the repair includes emitting laser light to ablate the location of the device corresponding to the detected defect.

16. The method of claim 14 further comprising:
performing the repair before the electrochromic device is cut from a panel including the electrochromic device among a plurality of electrochromic devices.

17. The method of claim 13 further comprising:
controlling a temperature of the electrochromic device when the thermal image is acquired.

18. A system for detecting and repairing a defect in an electrochromic device, the system comprising:
a thermal imaging unit to acquire a thermal image of an electrochromic device when the device is in an operating state;
a control unit to process thermal imaging data of the thermal image to detect a defect on the electrochromic device and to determine a location of the device corresponding to the detected defect;
a laser device unit to emit laser light to ablate the location of the device corresponding to the detected defect; and
a chiller unit to control a temperature of the device when the thermal image is acquired,
wherein the control unit compares a thermal amplitude detected at a pixel of the thermal image to a predetermined value to determine whether the pixel corresponds to a location of a defect in the device.
